(19) United States
(12) Patent Application Publication
(10) Pub. No.: US 2026/0290336 A1
(43) Pub. Date: Sep. 24, 2026

(54) VOICE PROCESSING DEVICE, OPERATION METHOD THEREOF, AND VEHICLE CONTROL SYSTEM COMPRISING VOICE PROCESSING DEVICE

(71) Applicant: AMOSENSE CO., LTD., Cheonan-si, Chungcheongnam-do (KR)

(72) Inventor: Jungmin KIM, Cheonan-si (KR)

(73) Assignee: AMOSENSE CO., LTD., Cheonan-si, Chungcheongnam-do (KR)

(21) Appl. No.: 19/168,039

(22) PCT Filed: Mar. 25, 2024
(86) PCT No.: PCT/KR2024/003664

§ 371 Date: Sep. 23, 2025

(30) Foreign Application Priority Data
Mar. 30, 2023 (KR) 10-2023-0041616

(51) Int. Cl. G10L 15/22; B60K 35/10; B60K 35/26; B60R 21/01; B60R 21/015

(52) U.S. Cl. CPC G10L 15/22; B60K 35/10; B60K 35/265; B60R 21/01512; B60K 2360/148; B60R 2021/0104

(57) ABSTRACT

A voice processing device, an operation method thereof, and a vehicle control system comprising same voice processing device. The voice processing device comprises: a microphone that is configured to respond to the voice of a passenger in the vehicle and generate a voice signal associated with the voice of the passenger; a speaker; and a processor that outputs, as a voice, a conversation attempt message to the passenger through the speaker when a collision occurrence signal is received from a vehicle controller configured to control the operation of the vehicle, processes response voice signals of the passenger with respect to the conversation attempt message, received from the microphone and generates sound source location information indicating a sound source location of the response voice signals, groups the response voice signals according to the sound source location information, and outputs the grouped response voice signal.

### TECHNICAL FIELD

Embodiments of the present disclosure relate to a voice processing device, an operation method thereof, and a vehicle control system including the voice processing device, and more particularly, to a voice processing device that can output information corresponding to an emergency situation occurring in a vehicle, an operation method thereof, and a vehicle control system including the voice processing device.

### BACKGROUND ART

An electric call (e-call) service system is a vehicle ICT-based service system that automatically transmits accident locations, accident information, etc., to emergency rescue agencies in the event of vehicle collisions and serious accidents, and requests emergency rescue to quickly save a life.

That is, the e-call service system transmits specific information, such as accident locations, vehicle type, traveling direction, and the number of seat belts operated in the event of an accident, to the nearest public-safety answering point (PSAP) in cooperation with a satellite position transmission system and a telecommunications company. The PSAP ascertains the received information and transmits the accident-related information to a rescue agency nearest to the accident location. Such a quick contact system allows rapid response to the accident to save a life.

The contents described in the Background Art are to help the understanding of the background of the disclosure, and may include contents that are not a disclosed conventional technology.

### DISCLOSURE

### Technical Problem

The present disclosure has been proposed in consideration of the above-described circumstances, and an object of the present disclosure is to provide a voice processing device that can output conversation content with passengers in the event of an emergency situation such as a vehicle collision, an operation method thereof, and a vehicle control system including the voice processing device.

### Technical Solution

A voice processing device according to embodiments of the present disclosure is a voice processing device installed in a vehicle and includes: a microphone configured to respond to a voice of a passenger in the vehicle and generate a voice signal associated with the voice of the passenger; a speaker configured to output a voice to the passenger in the vehicle; a memory; and a processor configured to load instructions stored in the memory and perform one or more operations according to an execution of the instructions, wherein, when a collision occurrence signal is received from a vehicle controller configured to control an operation of the vehicle, the processor outputs, as a voice, a conversation attempt message to the passenger through the speaker, processes response voice signals of the passenger with respect to the conversation attempt message received from the microphone, generates sound source location information indicating a sound source location of the response voice signals, groups the response voice signals according to the sound source location information, and outputs the grouped response voice signal.

The memory may store a plurality of candidate conversation attempt messages, and the processor may output, as a voice, a first candidate conversation attempt message among the plurality of candidate conversation attempt messages, and output, as a voice, a second candidate conversation attempt message following the first candidate conversation attempt message based on a response related to the response voice signals of the passenger with respect to the first candidate conversation attempt message.

The memory may store a plurality of candidate conversation attempt messages, and the processor may transmit the sound source location information to the vehicle controller, receive, from the vehicle controller, injury estimation information indicating a severity and a location of injury of the passenger at the sound source location estimated based on the sound source location information and sensing information of a sensor, and output, as a voice, a candidate conversation attempt message corresponding to the injury estimation information among the plurality of candidate conversation attempt messages.

The processor may analyze response voice signals at the sound source location to determine pitch and tone of a corresponding response voice signal, determine whether a passenger at the sound source location is a child passenger according to the determined pitch and tone, and output identification information indicating that the passenger at the sound source location is the child passenger when the passenger is determined to be the child passenger.

The memory may store a plurality of candidate conversation attempt messages, and the processor may output, as a voice, a candidate conversation attempt message corresponding to the child passenger among the plurality of candidate conversation attempt messages.

The processor may output the grouped response voice signal to an emergency rescue request device installed in the vehicle.

The processor may output the grouped response voice signal to a control server, and output sound source location information corresponding to the grouped response voice signal to an emergency rescue request device installed in the vehicle.

The processor may receive location information of the vehicle from the vehicle controller, and output location information of the vehicle at a time when the collision occurrence signal is received together with the grouped response voice signal.

An operation method of a voice processing device according to embodiments of the present disclosure is an operation method of a voice processing device installed in a vehicle and includes: outputting, as a voice, a conversation attempt message to a passenger in the vehicle when a collision occurrence signal is received from a vehicle controller configured to control an operation of the vehicle; processing response voice signals of the passenger with respect to the conversation attempt message to generate sound source location information indicating a sound source location of the response voice signals; grouping the response voice signals according to the sound source location information; and outputting the grouped response voice signal.

A vehicle control system according to embodiments of the present disclosure includes: a vehicle controller configured to control an operation of a vehicle; and a voice processing device configured to, when a collision occurrence signal is received from the vehicle controller, output, as a voice, a conversation attempt message to a passenger in the vehicle, to process response voice signals of the passenger with respect to the conversation attempt message, to generate sound source location information indicating a sound source location of the response voice signals, to group the response voice signals according to the sound source location information, and to output the grouped response voice signal.

### Advantageous Effects

According to the present disclosure having such a configuration, when an accident (e.g., a collision) occurs in a vehicle, since conversation content with passengers in a vehicle, sound source location information, and vehicle location information can be transmitted to a control server, the control server can more accurately ascertain accident details (e.g., the severity, location, etc., of injury of a passenger).

Therefore, the control server can instruct prompt and more accurate countermeasures.

Even in emergency accidents where passengers are unable to report directly, reports can be received, so that the passengers in the emergency situations can quickly receive emergency treatment and rescuers can shorten response times.

In addition, according to the present disclosure, rescuers not in an accident site can more accurately ascertain the situation inside a vehicle in the event of the accident, thereby appropriately making a rescue plan for accident treatment, and expediting accident treatment and emergency patient transport.

### DESCRIPTION OF DRAWINGS

FIG. 1 is a configuration diagram of a system including a vehicle employing a voice processing device according to an embodiment of the present disclosure and a control server networked with the vehicle.

FIG. 2 is a diagram for describing an operation of the voice processing device according to an embodiment of the present disclosure.

FIG. 3 is a diagram illustrating data transmitted from the vehicle to the control server in the event of an accident.

FIG. 4 is an internal configuration diagram of the voice processing device illustrated in FIG. 1.

FIG. 5 is a flowchart for describing an operation of the voice processing device according to an embodiment of the present disclosure.

### MODE FOR INVENTION

The present disclosure can have various modifications and various embodiments, and specific embodiments are illustrated in drawings and described in detail.

However, this is not intended to limit the present disclosure to specific embodiments, and it should be understood to include all modifications, equivalents, or substitutes included in the spirit and technical scope of the present disclosure.

Terms used in the present specification are used to only describe a specific embodiment, and are not intended to limit the present disclosure. An expression of the singular number includes an expression of the plural number unless clearly defined otherwise in the context. In this application, terms such as “comprises” or “has” are intended to designate the presence of features, numbers, steps, operations, components, parts, or combinations thereof described in the specification, and should be understood as not excluding the probability of the presence or addition of one or more other features, numbers, steps, operations, components, parts or combinations thereof in advance.

All terms used herein, including technical terms or scientific terms, have the same meanings as those commonly understood by a person having ordinary knowledge in the art to which the present disclosure pertains, unless defined otherwise in the specification. Terms, such as those defined in commonly used dictionaries, should be construed as having the same meanings as those in the context of a related technology, and are not construed as ideal or excessively formal meanings unless explicitly defined otherwise in the application.

Hereinafter, preferred embodiments of the present disclosure are described in more detail with reference to the accompanying drawings. In order to facilitate the overall understanding in describing the present disclosure, the same reference numerals are used for the same components in the drawings and a redundant description thereof is omitted.

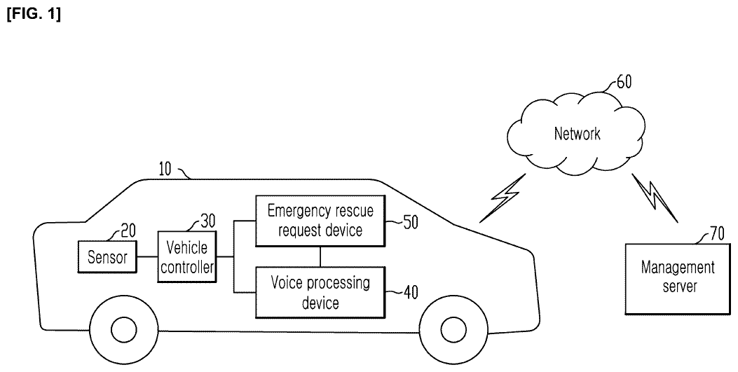

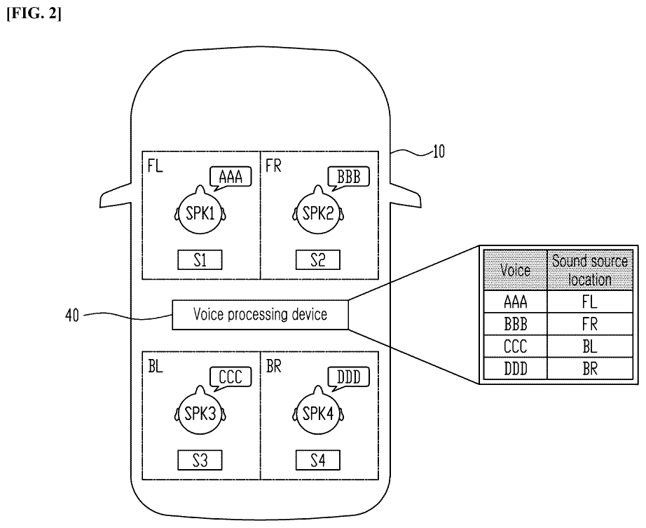

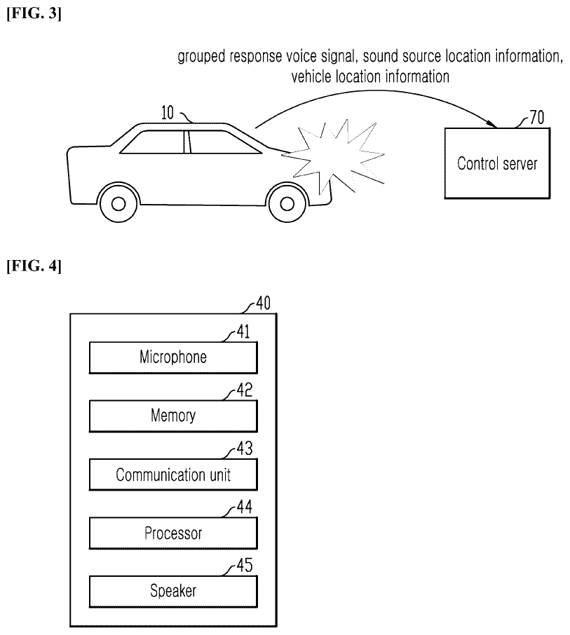

FIG. 1 is a configuration diagram of a system including a vehicle employing a voice processing device according to an embodiment of the present disclosure and a control server networked with the vehicle, FIG. 2 is a diagram for describing an operation of the voice processing device according to an embodiment of the present disclosure, and FIG. 3 is a diagram illustrating data transmitted from the vehicle to the control server in the event of an accident.

Referring to FIG. 1, a vehicle 10 can be defined as a means of transportation or transport that runs on roads, seaways, rail lines, and airways, such as automobiles, trains, motorcycles, ships, and aircraft. According to embodiments, the vehicle 10 may be a concept including all types of vehicles such as internal combustion engine vehicles provided with engines as power sources, hybrid vehicles provided with engines and electric motors as power sources, and electric vehicles provided with electric motors as power sources.

The vehicle 10 may be installed with a sensor 20, a vehicle controller 30, a voice processing device 40, and an emergency rescue request device 50. Although not illustrated in the drawing, the vehicle 10 is also installed with a steering device, a driving device, etc., in addition to them.

The sensor 20 may include a plurality of sensors and detect the state of the vehicle 10 to generate vehicle state information. The vehicle state information may include information on the current location of the vehicle 10, whether a collision has occurred, etc. As needed, the vehicle state information may further include information on the vehicle speed of the vehicle 10, surrounding obstacles, etc.

The sensor 20 can transmit the vehicle state information to the vehicle controller 30. Depending on the characteristics of the sensor, the vehicle state information may be an analog signal or a digital signal. Accordingly, the vehicle controller 30 may include an analog-to-digital (AD) converter (not illustrated) that, when the received vehicle state information is an analog signal, converts the vehicle state information as the analog signal into a digital signal, and a digital input buffer (not illustrated) that, when the received vehicle state information is a digital signal, buffers the vehicle state information as the digital signal.

The sensor 20 may include a GPS sensor capable of sensing the current location of the vehicle 10 in realtime, a collision sensor capable of detecting collisions between the vehicle 10 and other objects (e.g., other vehicles, obstacles, etc.), an obstacle sensor capable of detecting obstacles around the vehicle 10, a vehicle speed sensor capable of detecting the speed of the vehicle 10, an impact sensor, an acceleration sensor, etc.

Of course, as needed, the sensor 20 can detect internal/external information of the vehicle 10. Accordingly, the sensor 20 can additionally sense temperature and humidity inside/outside the vehicle 10, longitudinal/lateral acceleration, etc.

The vehicle controller 30 can be configured to control the operation of the vehicle 10.

The vehicle controller 30 can receive the vehicle state information from the sensor 20, and receive vehicle information through an OBD-II port of the vehicle 10. The vehicle information may refer to information on the state or the presence or absence of abnormality of components mounted or installed in the vehicle 10.

When a vehicle collision occurs, the vehicle controller 30 receives vehicle state information (particularly, a collision occurrence signal) from the sensor 20. Accordingly, the vehicle controller 30 can transmit the received vehicle state information (particularly, a collision occurrence signal) to the voice processing device 40.

The vehicle controller 30 may include, for example, an electronic control unit (ECU).

According to an embodiment, the vehicle controller 30 can receive sound source location information from the voice processing device 40, and receive various sensing information in the event of a vehicle collision from the sensor 20. The sound source location information may refer to sound source location information indicating a sound source location of response voice signals of a passenger with respect to a conversation attempt message. The various sensing information in the event of a vehicle collision may include, for example, a vehicle speed, longitudinal/lateral acceleration values, an impact value, etc. The vehicle controller 30 can estimate the severity and location of injury of the passenger at the sound source location based on the received sound source location information and sensor sensing information. For example, the vehicle controller 30 pre-stores information on the severity and location of injury of a passenger for each sound source location (i.e., boarding location) under various collision conditions. Accordingly, upon receiving the sound source location information and sensing information in the event of a vehicle collision, the vehicle controller 30 can read the information on the severity and location of injury of the passenger at the sound source location corresponding to the received sound source location information and sensor sensing information, thereby estimating the severity and location of injury. The vehicle controller 30 can transmit injury estimation information indicating the estimated severity and location of injury of the passenger at the sound source location to the voice processing device 40. Accordingly, the voice processing device 40 can output, as a voice, a candidate conversation attempt message corresponding to the injury estimation information among a plurality of pre-stored candidate conversation attempt messages. In this way, the voice processing device 40 can more quickly and accurately obtain answers regarding the severity, location, etc., of injury of the passenger.

On the other hand, the vehicle controller 30 can estimate the severity, location, etc., of injury of a passenger for each boarding location (i.e., sound source location) based on various sensing information from the sensor 20 in the event of a vehicle collision. The various sensing information from the sensor 20 in the event of a vehicle collision may include, for example, a vehicle speed, longitudinal/lateral acceleration values, an impact value, etc. The vehicle controller 30 pre-stores information on the severity and location of injury of a passenger for each sound source location (i.e., boarding location) under various collision conditions. Accordingly, upon receiving the sensing information in the event of a vehicle collision, the vehicle controller 30 can read the information on the severity and location of injury of the passenger at the sound source location corresponding to the received sensor sensing information, thereby estimating the severity and location of injury. Subsequently, the vehicle controller 30 receives passenger sound source location information and passenger identification information (indicating whether the passenger is an adult or a child) from the voice processing device 40. The “child” may refer to a child aged from one to six years in the international age. Based on the received information (i.e., the sound source location information and the identification information, or the sound source location information, the identification information, and the sensing information of the sensor 20), the vehicle controller 30 can predict the severity and location of injury of a passenger for each sound source location (i.e., boarding location). The estimation of the severity, location, etc., of injury of a passenger for each boarding location simply considers only a case where the passenger is an adult, and may be somewhat inaccurate when the passenger is a child. On the other hand, in the prediction of the severity, location, etc., of injury of a passenger for each boarding location, the severity, location, etc., of injury of a passenger are predicted in consideration of both adult and child passengers according to whether the passenger is an adult or a child. Even in vehicle collisions under the same conditions, since the severity and location of injury may differ between adults and children, the above-described predictive operation may be required. The vehicle controller 30 can transmit injury prediction information indicating the severity and location of injury predicted for each passenger for each sound source location (i.e., boarding location) to the voice processing device 40. Thus, the voice processing device 40 can receive the injury prediction information and output, as a voice, a conversation attempt message corresponding to the injury prediction information. In particular, since the voice processing device 40 can output, as a voice, a conversation attempt message corresponding to injury prediction information for a child passenger, it is possible to more quickly and accurately obtain answers regarding the severity, location, etc., of injury of both adult and child passengers.

In response to the voice of each of the passengers within the vehicle 10, the voice processing device 40 can generate voice signals associated with the voices of the passengers. The voice signal is a signal associated with voices pronounced over a specific period of time and may be a signal representing the voice of each of a plurality of passengers.

The voice processing device 40 can recognize the voices of the passengers on a passenger-by-passenger basis. When a plurality of passengers pronounce simultaneously, the voices of some passengers who pronounced are included in the voices. In order to accurately process the voice of each of the passengers, it is necessary to separate the voice of each passenger from the voices including all the voices of some passengers.

The voice processing device 40 according to embodiments of the present disclosure can determine, from voice signals associated with the voices of some passengers, the sound source location of the voice of each passenger and perform sound source separation based on the sound source location, thereby extracting (or generating) a separated voice signal associated with the voice of each passenger from the voice signal.

That is, based on the sound source locations (i.e., may be passenger boarding locations) of the voices, the voice processing device 40 can generate a separated voice signal associated with the voice at each sound source location. According to embodiments, the voice processing device 40 can classify components of a voice signal according to each sound source location, and generate a separated voice signal associated with the voice pronounced at each sound source location by using the classified components corresponding to each sound source location. For example, based on a voice signal, the voice processing device 40 can generate a first separated voice signal associated with a voice of a first passenger pronounced at a first sound source location. In such a case, the first separated voice signal may have the highest correlation with the voice of the first passenger among the voices of the passengers. In other words, the voice component of the first passenger may have the highest proportion among the voice components included in the first separated voice signal.

According to embodiments, the voice processing device 40 can use time delay (or phase delay) between voice signals associated with the voices of the passengers within the vehicle 10 to determine the sound source location of the voice of each passenger, and generate a separated voice signal corresponding only to a sound source at a specific location. For example, the voice processing device 40 can generate a separated voice signal associated with a voice pronounced at a specific location (or direction). Accordingly, the voice processing device 40 can generate a separated voice signals associated with the voice of each passenger. Through the operations required to generate such a separated voice signal, the voice processing device 40 can sufficiently generate response voice signals of a passenger at a specific sound source location with respect to a conversation attempt message and sound source location information indicating a sound source location of the response voice signals.

For example, as illustrated in FIG. 2, it is assumed that four passengers SPK1 to SPK4 are on board the vehicle 10 and can pronounce the voice. A first passenger SPK1 may be positioned in a left area FL of a front row of the vehicle 10, a second passenger SPK2 may be positioned in a right area FR of the front row of the vehicle 10, a third passenger SPK3 may be positioned in a left area BL of a rear row of the vehicle 10, and a fourth passenger SPK4 may be positioned in a right area BR of the rear row of the vehicle 10; however, embodiments of the present disclosure are not limited thereto. Speakers S1 to S4 can output voices corresponding to voice signals.

When the first to fourth passengers SPK1 to SPK4 pronounce predetermined voices within the vehicle 10, the voice processing device 40 can generate voice signals associated with the voices of the first to fourth passengers SPK1 to SPK4 in response to the voices of the first to fourth passengers SPK1 to SPK4. The voice signal is a signal associated with voices pronounced over a specific period of time and may be a signal representing the voices of a plurality of passengers.

Subsequently, the voice processing device 40 uses time delay (or phase delay) between the voice signals associated with the voices of the first to fourth passengers SPK1 to SPK4 to determine the sound source location of the voice of each of the first to fourth passengers SPK1 to SPK4, and extracts (or generates) a separated voice signal corresponding only to a sound source at a specific location. As illustrated in FIG. 2, it is assumed that the first passenger SPK1 pronounces a voice “AAA”, the second passenger SPK2 pronounces a voice “BBB”, the third passenger SPK3 pronounces a voice “CCC”, and the fourth passenger SPK4 pronounces a voice “DDD”. The voice processing device 40 can generate voice signals in response to the voices “AAA”, “BBB”, “CCC”, and “DDD”, and generate separated voice signals associated with the voices of the passengers SPK1 to SPK4 by using the generated voice signals.

For example, the voice processing device 40 can separate the voice signal according to the location of the sound source, thereby matching a first separated voice signal associated with the voice “AAA” of the first passenger SPK1 and first sound source location information indicating the left area FL of the front row being the sound source location of the voice “AAA” (i.e., the boarding location of the first passenger SPK1) and store the matched information. Similarly, the voice processing device 40 can match a second separated voice signal associated with the voice “BBB” of the second passenger SPK2 and second sound source location information indicating the right area FR of the front row of being the sound source location of the voice “BBB” (i.e., the boarding location of the second passenger SPK2) and store the matched information. In addition, the voice processing device 40 can match a third separated voice signal associated with the voice “CCC” of the third passenger SPK3 and third sound source location information indicating the left area BL of the rear row being the sound source location of the voice “CCC” (i.e., the boarding location of the third passenger SPK3) and store the matched information. In addition, the voice processing device 40 can match a fourth separated voice signal associated with the voice “DDD” of the fourth passenger SPK4 and fourth sound source location information indicating the right area BR of the rear row being the sound source location of the voice “DDD” (i.e., the boarding location of the fourth passenger SPK4) and store the matched information.

According to an embodiment, upon receiving a collision occurrence signal from the vehicle controller 30, the voice processing device 40 may output a predetermined conversation attempt message to a passenger as a voice.

Various detailed methods may be used to output the conversation attempt message as a voice. One example thereof is described below. The voice processing device 40 may pre-store a plurality of candidate conversation attempt messages. The plurality of candidate conversation attempt messages may be linked in a hierarchical query structure. Therefore, upon receiving a collision occurrence signal from the vehicle controller 30, the voice processing device 40 can output, as a voice, a first candidate conversation attempt message among the plurality of candidate conversation attempt messages in order to initiate a conversation with a passenger in the vehicle 10. The first candidate conversation attempt message may be a pre-designated message at an initial stage or a randomly selected message. Subsequently, the voice processing device 40 can output, as a voice, a second candidate conversation attempt message following the first candidate conversation attempt message based on a response related to the response voice signals of the passenger with respect to the first candidate conversation attempt message. The response related to the response voice signals may include whether the passenger has answered, the time required to answer, the magnitude (intensity) of the answer, and the content of the answer (e.g., positive or negative answer). That is, the second candidate conversation attempt message following the first candidate conversation attempt message is not unconditionally determined, and is selected and output as a voice according to the passenger's response (e.g., answer) to the first candidate conversation attempt message (e.g., a query).

Among the detailed methods for outputting the above-described conversation attempt message as a voice, a method different from the method exemplified above may consider injury of a passenger. That is, when a vehicle collision occurs, the passenger within the vehicle 10 may be injured. Accordingly, the voice processing device 40 can output, as a voice, a conversation attempt message in consideration of the severity, location, etc., of injury of the passenger. For example, the voice processing device 40 may pre-store a plurality of candidate conversation attempt messages. The plurality of candidate conversation attempt messages may be linked in a hierarchical query structure. The voice processing device 40 transmits sound source location information to the vehicle controller 30. The sound source location information may be generated by processing response voice signals of a passenger to a certain number of conversation attempt messages received after the vehicle collision. Of course, as needed, the sound source location information may be information generated in advance by determining the sound source location of each passenger's voice from voice signals associated with the passenger's voices received from the microphone 41 before the vehicle collision. The vehicle controller 30 estimates the severity and location of injury of a passenger at a corresponding sound source location based on the sound source location information and the sensing information of the sensor 20. The vehicle controller 30 generates injury estimation information indicating the severity and location of injury of the passenger at the estimated sound source location and transmits the injury estimation information to the voice processing device 40. Subsequently, the voice processing device 40 can receive the injury estimation information and output, as a voice, a candidate conversation attempt message corresponding to the injury estimation information among the plurality of candidate conversation attempt messages. The sensing information of the sensor 20 may include, for example, a vehicle speed, longitudinal/lateral acceleration values, an impact value, etc., and thus may be helpful in estimating the severity and location of injury of a passenger at a corresponding sound source location.

On the other hand, the vehicle controller 30 can receive passenger sound source location information and passenger identification information (information indicating whether a passenger is an adult or a child; identification information is described below) from the voice processing device 40, and receive various sensing information from the sensor 20 in the event of a vehicle collision. Based on the received information, the vehicle controller 30 can predict the severity, location, etc., of injury of a passenger for each sound source location (i.e., boarding location). For example, the vehicle controller 30 may have a table in which information such as the severity, location, etc., of injury of a passenger is matched according to the content of the sound source location, the identification information, and the sensor sensing information. Using such a table, the vehicle controller 30 can easily predict the severity, location, etc., of injury of a passenger for each sound source location. In such a case, the vehicle controller 30 uses more passenger identification information than the above-described estimation method, thereby more accurately predicting the severity, location, etc., of injury of a passenger for each sound source location. The vehicle controller 30 can transmit injury prediction information indicating injury severity and injury location predicted for a passenger for each sound source location (i.e., boarding location) to the voice processing device 40. Accordingly, the voice processing device 40 can receive the injury prediction information and output, as a voice, a candidate conversation attempt message corresponding to the injury prediction information among the plurality of candidate conversation attempt messages according to each sound source location. In particular, in the case of a child passenger, since the vehicle controller 30 can generate injury prediction information corresponding to the child passenger and transmit the injury prediction information to the voice processing device 40, the voice processing device 40 can output, as a voice, a conversation attempt message corresponding to the injury prediction information for the child passenger. This allows for an appropriate query (question) to be asked of the child passenger, taking into account injury severity and injury location.

In an embodiment, the voice processing device 40 can receive response voice signals of the passenger with respect to the conversation attempt message and process the received response voice signals to generate sound source location information indicating the sound source location of the response voice signals. Since the voice processing device 40 can classify the components of a voice signal of each passenger according to each sound source location, sound source location information indicating the sound source location can be sufficiently generated. The sound source location information may also be used to output the above-described conversation attempt message as a voice or to group the response voice signals of the passenger.

In an embodiment, the voice processing device 40 can group the response voice signals of the passenger according to the sound source location information. For example, the voice processing device 40 may generate a first group of response voice signals including only the response voice signals of the first passenger SPK1 at the first sound source location. The first group of response voice signals may be aligned in time series.

In an embodiment, the voice processing device 40 can transmit the grouped response voice signal and the sound source location information corresponding to the grouped response voice signal to the emergency rescue request device 50. Then, the emergency rescue request device 50 can transmit the grouped response voice signal and the sound source location information corresponding to the grouped response voice signal to the control server 70. Of course, as needed, the voice processing device 40 can directly transmit the grouped response voice signal to the control server 70, and transmit the sound source location information corresponding to the grouped response voice signal to the control server 70 through the emergency rescue request device 50.

The above grouped response voice signal may be a collection of answers to predetermined queries (questions). The first group of response voice signals described above may include only the response voice signals of the first passenger SPK1 at the first sound source location. When such a first group of response voice signals are transmitted to the control server 70, the control server 70 can more accurately ascertain the condition (injury severity, injury location, etc.) of a passenger (i.e., the first passenger SPK1) at a corresponding sound source location within the vehicle through the first group of response voice signals.

On the other hand, since a predetermined period of time is required to group response voice signals of a passenger, when a collision occurrence signal is received, the voice processing device 40 can group response voice signals of the passenger according to each sound source location for a preset period of time. In an embodiment, the voice processing device 40 can store the grouped response voice signal in an internal memory thereof and then output the grouped response voice signal stored in the internal memory.

In an embodiment, the voice processing device 40 can analyze response voice signals according to each sound source location, determine the pitch and tone of a corresponding response voice signal, and determine whether a passenger at a corresponding sound source location is a child passenger according to the determined pitch and tone. When the passenger is determined to be a child passenger, the voice processing device 40 can output identification information indicating that the passenger at the sound source location is a child passenger. Of course, when the passenger at the corresponding sound source location is determined to be an adult passenger, the voice processing device 40 can output identification information indicating that the passenger is an adult passenger. For example, when a case where a passenger is an adult is compared with a case where a passenger is a child, the pitch of the response voice signal (i.e., the pitch to the pronounce location) of the adult passenger may be higher than the pitch of the response voice signal (i.e., the pitch to the pronounce location) of the child passenger. In addition, the tone of the adult and the tone of the child may be different from each other. In this way, the voice processing device 40 can determine whether a passenger at a corresponding sound source location is a child passenger based on the pitch and tone of a response voice signal. That is, since it may be somewhat inaccurate to determine whether the passenger is an adult or a child based only on the pitch of the response voice signal, the tone of the response voice signal is used as another determination criterion.

The identification information indicating a child passenger can be transmitted to the control server 70 together with the grouped response voice signal. For example, the voice processing device 40 can transmit the grouped response voice signal, the sound source location information corresponding to the grouped response voice signal, and the identification information indicating the child passenger to the control server 70 through the emergency rescue request device 50. Of course, as needed, the voice processing device 40 can also directly transmit the grouped response voice signal to the control server 70, and transmit the sound source location information corresponding to the grouped response voice signal and the identification information indicating the child passenger to the control server 70 through the emergency rescue request device 50. As needed, the voice processing device 40 may include a communication unit (not illustrated) configured to exchange data (i.e., the grouped response voice signal) with the control server 70 by using radio waves of various frequencies in order to directly transmit the grouped response voice signal to the control server 70. The communication unit (not illustrated) within the voice processing device 40 can exchange data with the control server 70 according to at least one wireless communication mode of short-range wireless communication, medium-range wireless communication, and long-range wireless communication.

When the identification information indicating a child passenger is transmitted to the control server 70, the control server 70 can ascertain that the passengers include both an adult and a child through the identification information. This allows the control server 70 to issue more accurate countermeasure commands for not only adult rescue but also child rescue..

On the other hand, in the event of a vehicle collision, since adult and child passengers may differ in the type, location, etc., of an injury, conversation attempt messages need to different from each other. Therefore, the voice processing device 40 can output, as a voice, a candidate conversation attempt message corresponding to the child passenger among the plurality of candidate conversation attempt messages stored in the internal memory to the child passenger. That is, in order to more accurately inquire about the type, location, etc., of an injury suffered by the child passenger, in the case of the child passenger, a conversation attempt message appropriate for the child passenger (i.e., a candidate conversation attempt message) is preferably output as a voice.

In addition, the voice processing device 40 can receive vehicle location information from the vehicle controller 30 in real-time. Accordingly, when outputting a grouped response voice signal, sound source location information, etc., the voice processing device 40 can also output vehicle location information at the reception time of a collision occurrence signal.

On the other hand, when a vehicle collision occurs, the voice processing device 40 may receive vehicle location information in the event of the vehicle collision from the vehicle controller 30, instead of receiving the vehicle location information from the vehicle controller 30 in realtime. For example, when receiving a collision occurrence signal from the sensor 20, the vehicle controller 30 can also receive vehicle location information at that time and apply both the collision occurrence signal and the vehicle location information in the event of the vehicle collision to the voice processing device 40.

In FIG. 1, the emergency rescue request device 50 can be configured to receive the grouped response voice signal and transmit the received grouped response voice signal to the control server 70.

Of course, the emergency rescue request device 50 can transmit the current location information of the vehicle 10 and passenger sound source location information to the control server 70 together with the grouped response voice signal.

The emergency rescue request device 50 may include a communication unit (not illustrated) configured to exchange data with the control server 70 by using radio waves of various frequencies. The communication unit within the emergency rescue request device 50 may exchange data with the control server 70 by using at least one wireless communication mode of short-range wireless communication, medium-range wireless communication, and long-range wireless communication.

Accordingly, the vehicle 10 provided with the voice processing device 40 and the emergency rescue request device 50 can transmit the grouped response voice signal, the current location information of the vehicle 10, and the passenger sound source location information to the control server 70 when a vehicle collision occurs, as illustrated in FIG. 3.

In FIG. 1, the network 60 may refer to a connection structure that enables information exchange between the vehicle 10 and the control server 70.

The network 60 may have any structure that enables information exchange between the vehicle 10 and the control server 70.

In FIG. 1, in the event of an accident, such as a collision, the control server 70 can receive the grouped response voice signal, the current location information of the vehicle 10, and the passenger sound source location information from the vehicle 10. Of course, as needed, the control server 70 may also directly receive the grouped response voice signal from the voice processing device 40.

Based on the received grouped response voice signal, current location information of the vehicle 10, and passenger sound source location information, the control server 70 can more accurately ascertain the number of passengers inside the vehicle, the current condition of the passengers, etc., in the event of the vehicle collision. This allows the control server 70 to instruct prompt and more accurate countermeasures for the vehicle collision occurred.

In FIG. 1, the sensor 20, the vehicle controller 30, the voice processing device 40, and the emergency rescue request device 50 may be collectively referred to as a vehicle control system.

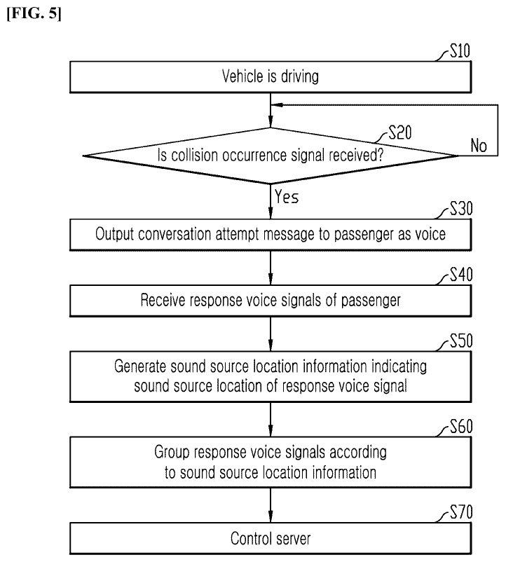

FIG. 4 is an internal configuration diagram of the voice processing device 40 illustrated in FIG. 1.

The voice processing device 40 may include a microphone 41, a memory 42, a communication unit 43, a processor 44, and a speaker 45.

The microphone 41 can generate a voice signal in response to a generated voice. According to embodiments, the microphone 41 can detect air vibration caused by a voice and generate a voice signal being an electrical signal corresponding to the vibration, according to the detection result. For example, the microphone 41 can receive voices of the passengers located within the vehicle 10 and convert the voices of the passengers into voice signals being electrical signals.

For example, the microphone 41 may include a plurality of microphones arranged in an array, and each of the plurality of microphones can generate a voice signal in response to a voice. Since the arrangement positions of the plurality of microphones may be different from each other, voice signals generated from the plurality of microphones may have a phase difference (or time delay) therebetween.

For example, the microphone 41 may be installed in the center fascia of the vehicle 10. The center fascia may refer to a control panel portion of a dashboard located between a driver's seat and a passenger's seat.

The present specification has described an example in which the voice processing device 40 includes the microphone 41 and directly generates a voice signal associated with the voices of passengers by using the microphone 41; however, according to embodiments, the microphone may be separate from the voice processing device 40 and configured outside the voice processing device 40. That is, the voice processing device 40 may receive a voice signal from the separately configured microphone and process or use the received voice signal. For example, the voice processing device 40 may generate a separated voice signal from the voice signal received from the separated microphone.

However, for convenience of explanation, unless otherwise specified, the following description is given on the assumption that the voice processing device 40 includes the microphone 41.

The memory 42 can store data necessary for the operation of the voice processing device 40. For example, the memory 42 may include at least one of a nonvolatile memory and a volatile memory.

According to embodiments, the memory 42 can store an identifier corresponding to each sound source location (i.e., each passenger's boarding location) within the vehicle 10. The identifier may be data for distinguishing sound source locations. Since sound source locations correspond to passengers, respectively, the passengers can be distinguished using identifiers corresponding to the sound source locations. For example, a first identifier indicating a first sound source location may indicate a first passenger. From such a perspective, an identifier corresponding to each sound source location within the vehicle 10 may also serve as a passenger identifier for identifying each passenger.

As needed, the identifier may be input through an input device (e.g., a touchpad; not illustrated) of the voice processing device 40.

According to embodiments, the memory 42 can store a grouped response voice signal and sound source location information related to the sound source location of each passenger. In addition, when the grouped response voice signal and the passenger sound source location information are stored in the memory 42, location information of the vehicle 10 at the reception time of a collision occurrence signal may also be stored.

The communication unit 43 is configured to exchange data with the vehicle controller 30 and/or the emergency rescue request device 50.

The processor 44 can control the overall operation of the voice processing device 40. According to embodiments, the processor 44 may include a processor having an operation processing function. For example, the processor 44 may include a central processing unit (CPU), a microcontroller unit (MCU), a graphics processing unit (GPU), a digital signal processor (DSP), an analog-to-digital converter (ADC), or a digital-to-analog converter (DAC), but is not limited thereto.

Unless otherwise specified, the operations of the voice processing device 40 described in the present specification can be understood as the operations of the processor 44.

The processor 44 can process voice signals generated by the microphone 41. For example, the processor 44 can convert an analog voice signal generated by the microphone 41 into a digital voice signal, and process the converted digital voice signal. In such a case, since the signal type (analog or digital) is changed, both the digital voice signal and the analog voice signal are interchangeably used in the description of embodiments of the present disclosure.

According to embodiments, the processor 44 can process a voice signal generated by the microphone 41 to extract (or generate) a voice signal associated with the voice of each passenger. According to embodiments, the processor 44 can generate separated voice signals associated with the voice of a passenger located at each sound source location. The separated voice signal may be in the form of voice data or text data.

The processor 44 can determine the sound source locations of voices of passengers by using time delay (or phase delay) between the separated voice signals. For example, the processor 44 can determine the relative positions of the sound sources (i.e., the relative positions of the passengers).

In other words, the processor 44 can classify the components of the voice signal according to each sound source location, and generate separated voice signals associated with voices pronounced at each sound source location by using the classified components corresponding to each sound source location. For example, the processor 44 can generate a first separated voice signal associated with the voice of a first passenger based on the sound source locations of the voices.

According to embodiments, the processor 44 can match sound source location information indicating the determined sound source location with a separated voice signal, and store the matched information. For example, the processor 44 can match the first separated voice signal associated with the voice of the first passenger with first sound source location information indicating the sound source location of the voice of the first passenger, and store the matched information in the memory 42. That is, since the sound source location directly corresponds to the boarding location of each passenger, the sound source location information may serve as passenger boarding location information for identifying the boarding location of each passenger.

According to embodiments, when a collision occurrence signal is received from the vehicle controller 30, the processor 44 can output a predetermined conversation attempt message to the passenger as a voice.

For example, when receiving the collision occurrence signal from the vehicle controller 30, the processor 44 can output, as a voice, a first candidate conversation attempt message among a plurality of candidate conversation attempt messages in order to initiate a conversation with the passenger within the vehicle 10. The plurality of candidate conversation attempt messages are connected in a hierarchical query structure and are stored in the memory 42 in advance. Subsequently, the processor 44 can output, as a voice, a second candidate conversation attempt message following the first candidate conversation attempt message based on a response related to response voice signals of the passenger with respect to the first candidate conversation attempt message (e.g., whether the passenger has answered, the time required to answer, the magnitude (intensity) of the answer, the positive or negative answer, etc.).

As another example, the processor 44 can process response voice signals of the passenger with respect to a conversation attempt message received from the microphone 41, generate sound source location information indicating the sound source location of the response voice signals, and transmit the generated sound source location information to the vehicle controller 30. The sound source location information may be information generated by processing the response voice signals of the passenger with respect to a conversation attempt message received some time after a vehicle collision. On the other hand, as needed, pre-generated sound source location information may be used by determining the sound source location of each of the voices of passengers from voice signals associated with the voices of the passengers received from the microphone 41 before a vehicle collision. The vehicle controller 30 estimates the severity and location of injury of a passenger at a corresponding sound source location based on the sound source location information and the sensing information of the sensor 20. The vehicle controller 30 generates injury estimation information indicating the estimated severity and location of injury of the passenger at the corresponding sound source location, and transmits the injury estimation information to the processor 44. Subsequently, the processor 44 can receive the injury estimation information and, output, as a voice, a candidate conversation attempt message corresponding to the injury estimation information among the plurality of candidate conversation attempt messages. The sensing information of the sensor 20 may include, for example, a vehicle speed, longitudinal/lateral acceleration values, an impact value, etc., and thus may be helpful in estimating the severity and location of injury of a passenger at the sound source location. The plurality of candidate conversation attempt messages are stored in the memory 42 in advance.

As another example, the processor 44 can receive, from the vehicle controller 30, passenger injury estimation information for each sound source location (i.e., boarding location) generated based on the passenger sound source location information, the passenger identification information, and the sensing information of the sensor 20 in the event of a vehicle collision. Accordingly, the processor 44 can output, as a voice, a candidate conversation attempt message corresponding to the injury estimation information, among the plurality of candidate conversation attempt messages, for each sound source location.

The processor 44 can group the response voice signals of each passenger according to sound source location information generated after a collision occurrence signal is received. For example, the processor 44 can generate a first group of response voice signals including only the response voice signals of the first passenger SPK1 at the first sound source location. The first group of response voice signals may be aligned in time series.

On the other hand, since a predetermined period of time is required to group response voice signals of a passenger, when a collision occurrence signal is received, the processor 44 can group response voice signals of the passenger according to each sound source location for a preset period of time. In an embodiment, the processor 44 can store the grouped response voice signal in the memory 42 and then output the grouped response voice signal stored in the memory 42.

Subsequently, the processor 44 can transmit the grouped response voice signal and sound source location information corresponding to the grouped response voice signal to the emergency rescue request device 50. Of course, as needed, the processor 44 can directly transmit the grouped response voice signal to the control server 70, and transmit the sound source location information corresponding to the grouped response voice signal to the control server 70 through the emergency rescue request device 50. Since the sound source location of the passenger may correspond to the boarding location of the passenger, the sound source location information may be considered as passenger boarding location information.

In an embodiment, the processor 44 can analyze response voice signals according to each sound source location, determine the pitch and tone of a corresponding response voice signal, and determine whether a passenger at a corresponding sound source location is a child passenger according to the determined pitch and tone. When the passenger is determined to be a child passenger, the processor 44 can output identification information indicating that the passenger at the sound source location is a child passenger. Of course, when the passenger at the corresponding sound source location is determined to be an adult passenger, the processor 44 can output identification information indicating that the passenger is an adult passenger.

The processor 44 can transmit the identification information indicating a child passenger to the control server 70 together with the grouped response voice signal. For example, the processor 44 can transmit the grouped response voice signal, the sound source location information corresponding to the grouped response voice signal, and the identification information indicating the child passenger to the control server 70 through the emergency rescue request device 50. Of course, as needed, the processor 44 can also directly transmit the grouped response voice signal to the control server 70, and transmit the sound source location information corresponding to the grouped response voice signal and the identification information indicating the child passenger to the control server 70 through the emergency rescue request device 50.

When the identification information indicating a child passenger is transmitted to the control server 70, the control server 70 can ascertain the presence of a child passenger among the passengers, thereby issuing more accurate countermeasure commands for not only adult rescue but also child rescue.

In the event of a vehicle collision, since adult and child passengers may differ in the type, location, etc., of an injury, conversation attempt messages need to different from each other. Therefore, the processor 44 can, as a voice, output a candidate conversation attempt message corresponding to the child passenger among the plurality of candidate conversation attempt messages stored in the internal memory to the child passenger. That is, in order to more accurately inquire about the type, location, etc., of an injury suffered by the child passenger, in the case of the child passenger, a conversation attempt message appropriate for the child passenger (i.e., a candidate conversation attempt message) is preferably output as a voice.

In addition, the processor 44 can receive vehicle location information in the event of a vehicle collision (i.e., when a collision occurrence signal is received) from the vehicle controller 30. Accordingly, when outputting the grouped response voice signal and the sound source location information, the processor 44 can also output the vehicle location information at the reception time of the collision occurrence signal.

The operations of the processor 44 or the voice processing device 40 described in the present specification can be implemented in the form of a program executable by a computing device. For example, the processor 44 can execute an application stored in the memory 42 and perform operations corresponding to instructions that instruct specific operations according to the execution of the application.

The speaker 45 can vibrate under the control of the processor 44, and voice can be generated according to the vibration. According to embodiments, the speaker 45 can form a vibration corresponding to a voice signal, thereby reproducing voice associated with the voice signal.

According to embodiments, the speaker 45 may include a plurality of the speakers S1 to S4 (see FIG. 2). The speakers S1 to S4 can generate vibrations based on voice signals, and voice can be reproduced according to the vibrations of the speakers S1 to S4. The speakers S1 to S4 can be arranged at the locations of the passengers SPK1 to SPK4, respectively. For example, each of the speakers S1 to S4 may be a speaker located on a headrest of a seat where each of the passengers SPK1 to SPK4 is located. However, embodiments of the present disclosure are not limited thereto.

On the other hand, the present specification has described an example in which the voice processing device 40 includes the speaker 45 and outputs a conversation attempt message as a voice by using the speaker 45. However, according to embodiments, the speaker 45 may also be separate from the voice processing device 40 and configured outside the voice processing device 40. That is, the voice processing device 40 may output, as a voice, a conversation attempt message through the speaker 45 included therein, or may output, as a voice, a conversation attempt message by using the speakers S1 to S4 configured separately as illustrated in FIG. 2.

FIG. 5 is a flowchart for describing the operation of the voice processing device according to an embodiment of the present disclosure.

First, the vehicle 10 is driving (S10).

When the voice processing device 40 receives a collision occurrence signal from the vehicle controller 30 while the vehicle 10 is driving (“Yes” at S20), the voice processing device 40 outputs a predetermined conversation attempt message to the passengers as a voice (S30). The conversation attempt message can be output through the speakers S1 to S4 (see FIG. 2) arranged at the boarding positions of the passengers.

Accordingly, the passengers within the vehicle 10 can make an answer with their own voices as a response to the conversation attempt message.

Accordingly, the microphone 41 of the voice processing device 40 receives the response voice signals of the passenger to the conversation attempt message (S40).

Thus, the voice processing device 40 processes the received response voice signals of the passenger to generate sound source location information indicating the sound source location of the response voice signals (S50). For example, the voice processing device 40 can classify the components of the voice signal according to each sound source location. By employing such a method, the voice processing device 40 can sufficiently generate sound source location information from the response voice signals of the passenger.

After generating the passenger sound source location information in this manner, the voice processing device 40 groups response voice signals at each sound source location by using the sound source location information (i.e., voice signals associated with the voice response of the passengers to the conversation attempt message at respective boarding locations) (S60). It is assumed that the four passengers SPK1 to SPK4 are present in the vehicle 10 and are slightly injured. In such a case, the voice processing device 40 can generate a first group of response voice signals including only response voice signals of the first passenger SPK1, a second group of response voice signals including only response voice signals of the second passenger SPK2, a third group of response voice signals including only response voice signals of the third passenger SPK3, and a fourth group of response voice signals including only response voice signals of the fourth passenger SPK4.

Subsequently, the voice processing device 40 outputs the grouped response voice signals (S70). In such a case, the voice processing device 40 can transmit the grouped response voice signals, respective sound source location information corresponding to the grouped response voice signals, and the vehicle location information at the reception time of a collision occurrence signal to the emergency rescue request device 50. Subsequently, the emergency rescue request device 50 can transmit the grouped response voice signals, the respective sound source location information corresponding to the grouped response voice signals, and the vehicle location information at the reception time of the collision occurrence signal to the control server 70. Of course, as needed, the voice processing device 40 can directly transmit the grouped response voice signals to the control server 70, and transmit the respective sound source location information corresponding to the grouped response voice signals and the vehicle location information at the reception time of the collision occurrence signal to the control server 70 through the emergency rescue request device 50.

Therefore, based on the grouped response voice signals, the respective sound source location information corresponding to the grouped response voice signals, and the vehicle location information at the reception time of the collision occurrence signal, the control server 70 can more accurately ascertain the number of passengers inside the vehicle in the event of a vehicle accident, the current condition of the passengers (injury severity and injury location), etc. Accordingly, the control server 70 can instruct prompt and more accurate countermeasures for the occurrence of a vehicle accident.

In addition, the operation method of the voice processing device of the present disclosure described above can be implemented with computer-readable codes on a computer-readable recording medium. The computer-readable recording medium includes all types of recording devices that store data that can be read by a computer system. Examples of the computer-readable recording medium include a ROM, an RAM, a CD-ROM, a magnetic tape, a floppy disk, and an optical data storage device. In addition, the computer-readable recording medium can be distributed to computer systems connected through a network, and can store computer-readable codes executable in a distributed manner. In addition, functional programs, codes, and code segments for implementing the above method can be readily inferred by programmers skilled in the art to which the present disclosure pertains.

The above description is merely intended to illustratively describe the technical spirit of the present disclosure, and various changes and modifications can be made by those skilled in the art to which the present disclosure pertains without departing from the essential features of the present disclosure. Therefore, the embodiments disclosed in the present disclosure are not intended to limit the technical spirit of the present disclosure, but are intended to describe the present disclosure. The scope of the technical spirit of the present disclosure is not limited by these embodiments. The scope of the present disclosure should be interpreted by the accompanying claims and all technical spirits falling within the equivalent scope thereto should be interpreted as being included in the scope of the present disclosure.

1. A voice processing device installed in a vehicle, the voice processing device comprising:
a microphone configured to respond to a voice of a passenger in the vehicle and generate a voice signal associated with the voice of the passenger;
a speaker configured to output a voice to the passenger in the vehicle;
a memory; and
a processor configured to load instructions stored in the memory and perform one or more operations according to an execution of the instructions,
wherein, when a collision occurrence signal is received from a vehicle controller configured to control an operation of the vehicle, the processor outputs, as a voice, a conversation attempt message to the passenger through the speaker,
processes response voice signals of the passenger with respect to the conversation attempt message received from the microphone, generates sound source location information indicating a sound source location of the response voice signals,
groups the response voice signals according to the sound source location information, and
outputs the grouped response voice signal.

2. The voice processing device of claim 1, wherein the memory stores a plurality of candidate conversation attempt messages, and
the processor outputs, as a voice, a first candidate conversation attempt message among the plurality of candidate conversation attempt messages, and outputs, as a voice, a second candidate conversation attempt message following the first candidate conversation attempt message based on a response related to the response voice signals of the passenger with respect to the first candidate conversation attempt message.

3. The voice processing device of claim 1, wherein the memory stores a plurality of candidate conversation attempt messages, and
the processor transmits the sound source location information to the vehicle controller,
receives, from the vehicle controller, injury estimation information indicating a severity and a location of injury of the passenger at the sound source location estimated based on the sound source location information and sensing information of a sensor, and
outputs, as a voice, a candidate conversation attempt message corresponding to the injury estimation information among the plurality of candidate conversation attempt messages.

4. The voice processing device of claim 1, wherein the processor analyzes response voice signals at the sound source location to determine pitch and tone of a corresponding response voice signal,
determines whether a passenger at the sound source location is a child passenger according to the determined pitch and tone, and
outputs identification information indicating that the passenger at the sound source location is the child passenger when the passenger is determined to be the child passenger.

5. The voice processing device of claim 4, wherein the memory stores a plurality of candidate conversation attempt messages, and
the processor outputs, as a voice, a candidate conversation attempt message corresponding to the child passenger among the plurality of candidate conversation attempt messages.

6. The voice processing device of claim 1, wherein the processor outputs the grouped response voice signal to an emergency rescue request device installed in the vehicle.

7. The voice processing device of claim 1, wherein the processor outputs the grouped response voice signal to a control server, and outputs sound source location information corresponding to the grouped response voice signal to an emergency rescue request device installed in the vehicle.

8. The voice processing device of claim 1, wherein the processor receives location information of the vehicle from the vehicle controller, and outputs location information of the vehicle at a time when the collision occurrence signal is received together with the grouped response voice signal.

9. An operation method of a voice processing device installed in a vehicle, the operation method comprising:
outputting, as a voice, a conversation attempt message to a passenger in the vehicle when a collision occurrence signal is received from a vehicle controller configured to control an operation of the vehicle;
processing response voice signals of the passenger with respect to the conversation attempt message to generate sound source location information indicating a sound source location of the response voice signals;
grouping the response voice signals according to the sound source location information; and
outputting the grouped response voice signal.

10. A vehicle control system comprising:
a vehicle controller configured to control an operation of a vehicle; and
a voice processing device configured to, when a collision occurrence signal is received from the vehicle controller, output, as a voice, a conversation attempt message to a passenger in the vehicle, to process response voice signals of the passenger with respect to the conversation attempt message, to generate sound source location information indicating a sound source location of the response voice signals, to group the response voice signals according to the sound source location information, and to output the grouped response voice signal.

11. The vehicle control system of claim 10, wherein the voice processing device stores a plurality of candidate conversation attempt messages,
transmits the sound source location information to the vehicle controller,
receives, from the vehicle controller, injury estimation information indicating a severity and a location of injury of the passenger at the sound source location estimated based on the sound source location information and sensing information of a sensor, and
outputs, as a voice, a candidate conversation attempt message corresponding to the injury estimation information among the plurality of candidate conversation attempt messages.

12. The vehicle control system of claim 10, wherein the voice processing device analyzes response voice signals at the sound source location to determine tone,
determines whether a passenger at the sound source location is a child passenger according to the determined tone, and
outputs identification information indicating that the passenger at the sound source location is the child passenger when the passenger is determined to be the child passenger.

13. The vehicle control system of claim 12, wherein the vehicle controller receives the sound source location information, the identification information, and the sensing information of the sensor,
predicts a severity and a location of injury of the child passenger based on the sound source location information, the identification information, and the sensing information of the sensor, and
outputs injury prediction information based on the prediction to the voice processing device.

14. The vehicle control system of claim 13, wherein the voice processing device receives the injury prediction information and outputs, as a voice, a conversation attempt message corresponding to the injury prediction information to the child passenger.

15. The vehicle control system of claim 10, wherein the voice processing device stores a plurality of candidate conversation attempt messages,
outputs, as a voice, a first candidate conversation attempt message among the plurality of candidate conversation attempt messages, and
outputs, as a voice, a second candidate conversation attempt message following the first candidate conversation attempt message based on a response related to the response voice signals of the passenger with respect to the first candidate conversation attempt message.
